(19) United States
(12) Patent Application Publication
(10) Pub. No.: US 2008/0073859 A1
(43) Pub. Date: Mar. 27, 2008

(54) Sealing arrangement

(76) Inventors: Wilhelm Kullen, Hulben (DE); Wolfgang Eben, Munsingen/Apfelstetten (DE); Wolfgang Gebhardt, Hulben (DE); Hansjurgen Mattheis, Blaubeuren (DE); Martin Kehr, Bad Urach (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/902,949

(22) Filed: Sep. 26, 2007

(30) Foreign Application Priority Data
Sep. 27, 2006 (DE) 10 2006 045 583.5

(51) Int. Cl. F16J 15/08

(52) U.S. Cl. 277/614

(57) ABSTRACT

A sealing arrangement, in particular for pipe connections to the exhaust gas system of an internal combustion engine, with a sealing support and at least one sealing element in the form of a ring element (25) that forms a mold seal, is characterized in that a holding device (27) that produces a frictional connection between sealing support and ring element (25) is provided to secure the latter captively to the sealing support.

The invention relates to a sealing arrangement, in particular for pipe connections to the exhaust gas system of an internal combustion engine, with a sealing support and at least one sealing element in the form of a ring element that forms a mold seal.

Sealing arrangements of this type are widely used in attachment connections of exhaust-gas-carrying pipes, for example for connections of pipes to catalytic converters or cylinder heads of internal combustion engines. Based on the high exhaust gas temperatures that occur, the respective ring element is a metallic component with a smaller wall thickness, the ring element usually having a profiled configuration, for example in the form of a C-profile.

In a disadvantageous way, the assembly process of such multi-part sealing arrangements is configured in a comparatively complicated manner, since during production of the connection, care must be taken that the ring element is actually present and correctly positioned between the respective connecting parts.

With respect to this prior art, the object of the invention is to make available a sealing arrangement, which is provided in particular for pipe connections to the exhaust gas system of internal combustion engines, in which the assembly process can be carried out comparatively more simply and more safely.

According to the invention, this object is achieved by a sealing arrangement that has the features of claim 1 in its entirety.

Since the sealing arrangement according to the invention forms a unit that captively contains the respective ring element, the entire operating sequence is configured in an especially simple and safe manner during assembly since neither during the supply of the sealing arrangements in the actual assembly position, which takes place in an automated fashion in industrial manufacturing, nor in the actual connecting process must it be considered whether the respective ring element is present and correctly positioned.

In especially advantageous embodiments in which the ring element that forms the mold seal has a C-, U- or V-shaped profile in cross-section, several collars can be molded as a holding device onto one edge of the profile, and said collars form catches that project slightly on the peripheral side on the profile, whereby said catches flexibly deform to produce a frictional connection on the sealing support when the ring element is attached to the sealing support and thus secure the ring element on the sealing support in the form of spring clips.

The collars can be molded onto a radial outer edge of the profile of the ring element or on a radial inner edge of the profile of the ring element. Depending on the type of design of the sealing support and the respective arrangement of the ring element, the catches can thus grip an inside diameter or an outside diameter.

If the sealing support is a flat plate with at least one opening for the exhaust gas flow and the ring element extends along the edge of the respective opening, the frictional connection effecting captive retention can be produced by pressing the collars into the opening edge of the plate opening.

In especially advantageous embodiments, the sealing support as a seat for the ring element has a ring-shaped recess, which surrounds a channel that leads to the exhaust gas flow and is bordered by a wall that extends in an axial direction, with which the collars that form the catches work together.

For this purpose, the arrangement can be designed such that the ring-shaped recess on its radial inner end is open toward the channel that leads to the exhaust gas flow, on a radial outer wall of the recess, a frictional connection being produced with the collars that act as catches.

As an alternative, the recess can have the shape of an annular groove with two walls that exhibit a radial distance from one another and that extend in an axial direction, from which on the radial inner or outer wall, a frictional connection is produced with the collars that act as catches. In such an embodiment, the annular groove forms a chamber for the ring element, by which considerable advantages emerge both with respect to the captive securing of the ring element and with respect to the operating safety of the seal that is formed.

The subject of the invention is also a ring element that is provided for use as a mold seal in the sealing arrangement according to the invention and has the features of claim 10. Additional design features of the ring element according to the invention are indicated in claims 11 to 13.

Below, the invention will be explained in detail based on the embodiments depicted in the drawing. Here:

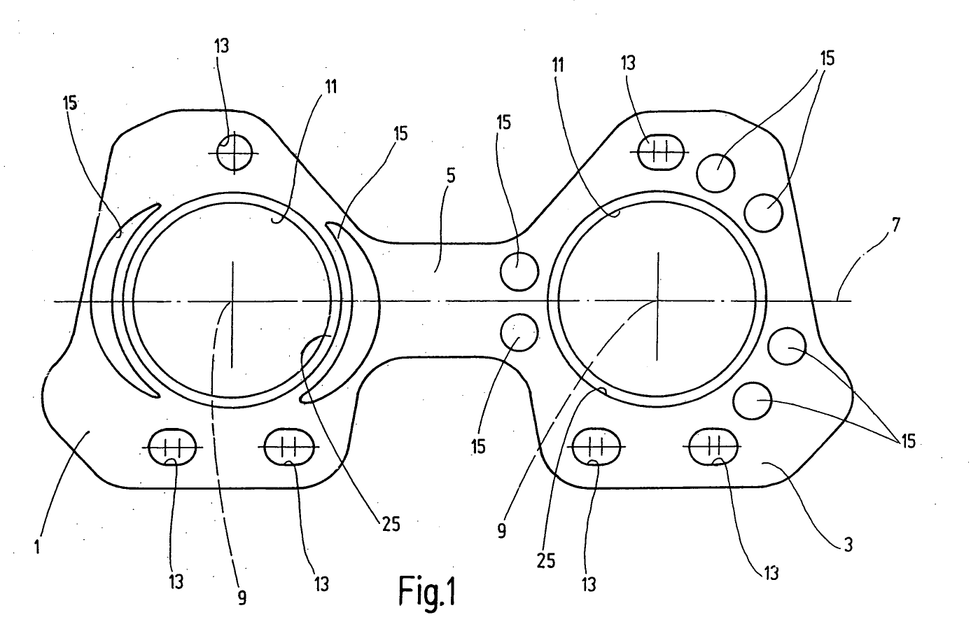

FIG. 1 shows a top view of an embodiment of the sealing arrangement in the form of a so-called gland for use in the attachment connection between an exhaust gas manifold and a cylinder head, a flat plate being provided as a sealing support and different embodiments of the plate being shown on the right side and the left side in the figure, which are distinguished by differently molded openings for thermal decoupling;

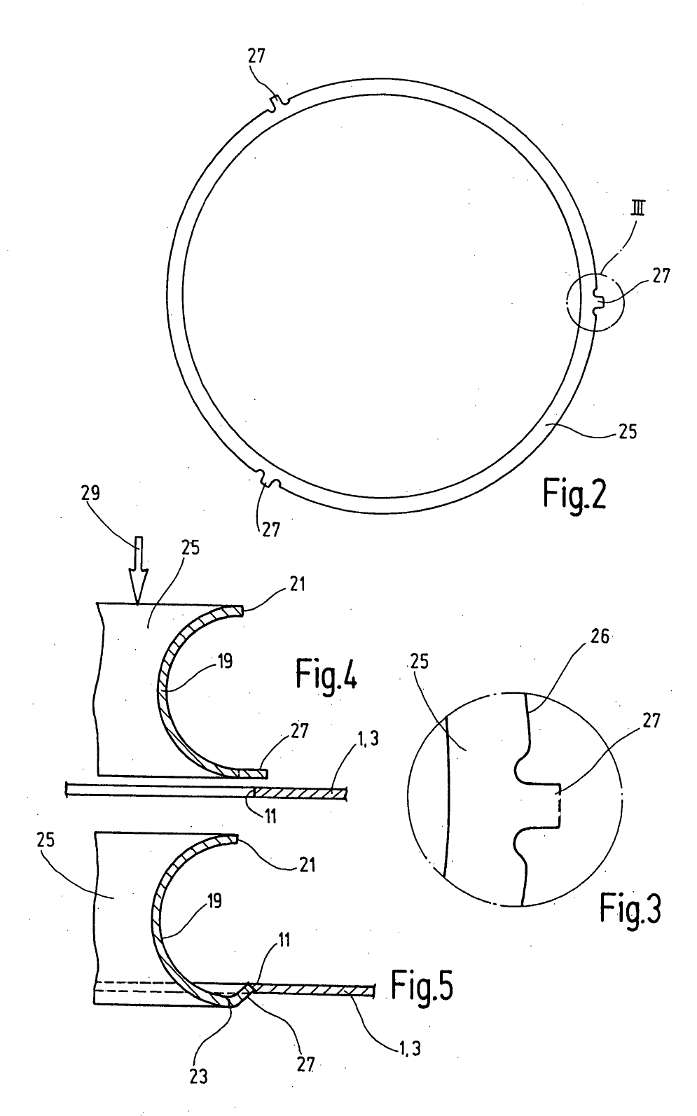

FIG. 2 shows a top view of the ring element, forming a mold seal, of the sealing arrangement according to the invention;

FIG. 3 shows a greatly enlarged detail view of the area defined as III in FIG. 2;

FIG. 4 shows a partial cross-section of the ring element of FIG. 2, greatly enlarged compared to FIG. 2 and drawn in cutaway, and the associated edge section of the opening of the plate of FIG. 1, the condition before attaching the ring element on the plate being shown;

FIG. 5 shows a view that corresponds to FIG. 4, the ring element being shown after the plate is inserted into the opening;

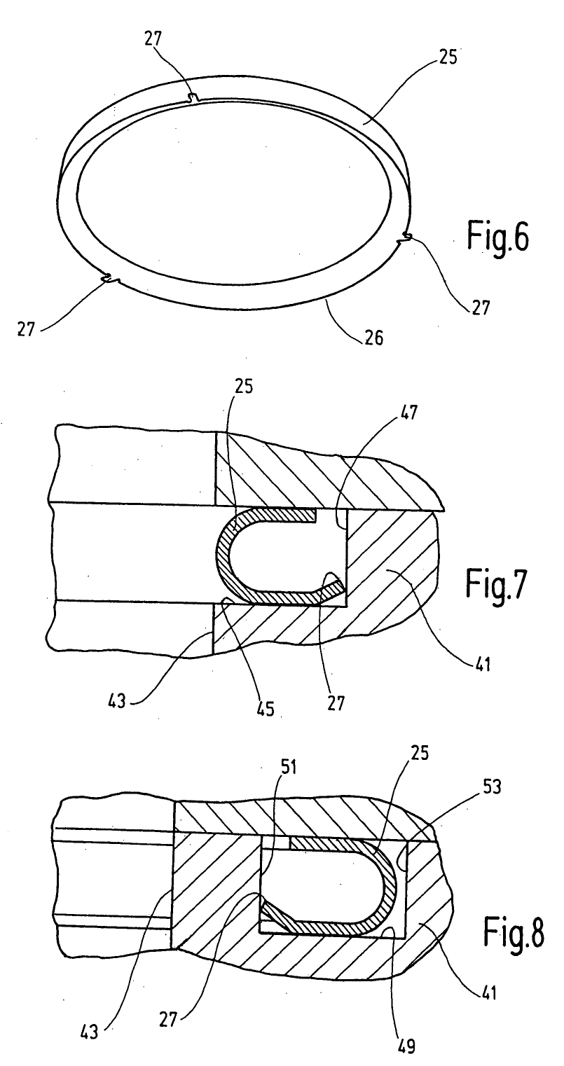

FIG. 6 shows a perspective oblique view of the ring element of the sealing arrangement according to the invention;

FIG. 7 shows a partial cross-section of the ring element that is greatly enlarged compared to FIG. 6, inserted into a recess that acts as a seat of the ring element in a connecting flange that forms the sealing support, and

FIG. 8 shows a partial cross-section, similar to FIG. 7, with, however, on its radial inner profile edge, the ring element being equipped with projecting collars that form catches and being installed in a seat of the sealing support that is formed by an annular groove.

The invention will be explained in greater detail below on the basis of an example, in which the sealing arrangement has the form of a so-called gland, in which a flat metal plate that forms the sealing support has two plate areas 1 and 3 that are integrally connected together via a comparatively narrow plate arm 5, the arm 5 extending along the longitudinal axis 7 of the sealing arrangement. With the center of the circle 9 placed on the longitudinal axis 7, there is one circular opening 11 each for the passage of an exhaust gas flow, which emerges from a respective exhaust opening of a cylinder head (not shown), in each plate area 1 and 3. Screw holes 13 that are located in the two plate areas 1 and 3 are provided for fastening screws, which attach a manifold, not shown, and the sealing arrangement to the cylinder head.

In addition to the screw holes 13, holes 15, which aim at a reduction of the heat-conducting surface area of the sealing arrangement and thus a thermal decoupling between cylinder head and exhaust gas manifold, are located in the plate areas 1 and 3. In FIG. 1, two different embodiments are illustrated for the holes 15; specifically crescent-shaped holes 15 are provided in the plate area 1 on the left, while holes 15 in the form of round holes are provided in the plate area 3 on the right.

For each opening 11, a metal ring element 25 (see FIG. 2) is provided, which has the cross-sectional shape of a C-profile 19. As is the case in the plate with the plate areas 1 and 3, the ring element 25 is also a thin-walled metal component whose wall thickness, as is the case with the plate, is, for example, in the range of 0.3 mm. For a captive securing of the ring element 25 on the respective opening 11 in the associated plate area 1, 3, the ring element 25 has three retaining collars 27 on the profile edge that is opposite its radial outer end 21, and said retaining collars are distributed uniformly on the periphery of the ring element 25, see FIG. 2. As shown most clearly by the enlarged view of FIG. 3, the retaining collars 27 in the (undeformed) initial condition form catch-like projections that project slightly radially on the respective peripheral edge 26 of the ring element 25.

FIG. 4 shows the initial condition shortly before the application of the ring element 25 on the edge of the opening 11 of the respective plate area 1, 3, it being apparent that the retaining collars 27 extend slightly radially outward over the edge of the opening 11. If the ring element is forced into the opening 11 by applying a compressive force corresponding to the force arrow 29, a flexible deformation of the retaining collars 27 occurs when pressing into the opening 11, see FIG. 5, by which a frictional connection, which acts as a holding force, is produced on the opening 11, by which the ring element 25 is held captively on the opening 11.

The ring element 25 can be slightly deformed on its peripheral edge 26 that has the retaining collars 27 by the compressive force that is exerted when it is depressed, by which the compressive force, forming the C-profile 19, produces a slight curvature 23 below the plate 1, 3. FIG. 5 therefore shows a curvature 23 for the ring element 25 on its edge opposite the profile end 21 (peripheral edge 26 in FIG. 3).

Based on FIGS. 6 to 8, a preferred embodiment of the sealing arrangement is explained, in which the sealing support is not a flat plate but rather in which a connecting flange 41, which is located on the outside of an exhaust-gas-carrying channel 43, forms the sealing support. FIG. 7 shows an example in which the seat for the ring element 25 is formed by a ring-shaped recess 45 that is created in the abutting face of the flange 41, which is open on the radial inner end toward the exhaust gas channel 43 and is bordered on the radial outer end by a wall 47 that extends in the axial direction. In the recess 45, the ring element 25 with its retaining collars 27, which are located on the radial outer peripheral edge 26 corresponding to the view of FIG. 6, is installed in the seat, such that the collars 27 are supported under slight flexible deformation as catches on the wall 47 of the recess 45.

FIG. 8 shows an example in which the profile of the ring element 25, unlike in the example of FIGS. 4 to 7, is opened radially inward, and the retaining collars 27 are located on a radial inner profile edge. In this embodiment, an annular groove 49 that surrounds the exhaust gas channel 43 is created in the flange 41 that forms the sealing support instead of the recess 45 that is shown in FIG. 7, and said annular groove 49 is bordered by a radial inner wall 51 that extends in an axial direction and a radial outer wall 53 that extends in an axial direction. In this connection, the retaining collars 27 are supported on the radial inner wall 51, in the same way as in FIG. 7, the frictional connection that ensures captive retention being formed. Also, in the example of FIG. 8, where the annular groove 49 forms a chamber for the ring element 25, a ring element 25 could be installed in the annular groove 49 with a profile that is open radially outward, whereby the retaining collars 27 would be clamped on the radial outer wall 53 as catches. Also, the term “sealing ring or mold” also extends to ring embodiments with oval shape or those with a rectangular design, preferably the corners of the rectangle being designed in a rounded way. Other ring shapes are possible here. In this respect, the respective images of the mold or sealing ring preferably follow the respective geometry thereof.

The invention relates to a sealing arrangement, in particular for pipe connections to the exhaust gas system of an internal combustion engine, with a sealing support and at least one sealing element in the form of a ring element that forms a mold seal.

Sealing arrangements of this type are widely used in attachment connections of exhaust-gas-carrying pipes, for example for connections of pipes to catalytic converters or cylinder heads of internal combustion engines. Based on the high exhaust gas temperatures that occur, the respective ring element is a metallic component with a smaller wall thickness, the ring element usually having a profiled configuration, for example in the form of a C-profile.

In a disadvantageous way, the assembly process of such multi-part sealing arrangements is configured in a comparatively complicated manner, since during production of the connection, care must be taken that the ring element is actually present and correctly positioned between the respective connecting parts.

With respect to this prior art, the object of the invention is to make available a sealing arrangement, which is provided in particular for pipe connections to the exhaust gas system of internal combustion engines, in which the assembly process can be carried out comparatively more simply and more safely.

According to the invention, this object is achieved by a sealing arrangement that has the features of claim 1 in its entirety.

Since the sealing arrangement according to the invention forms a unit that captively contains the respective ring element, the entire operating sequence is configured in an especially simple and safe manner during assembly since neither during the supply of the sealing arrangements in the actual assembly position, which takes place in an automated fashion in industrial manufacturing, nor in the actual connecting process must it be considered whether the respective ring element is present and correctly positioned.

In especially advantageous embodiments in which the ring element that forms the mold seal has a C-, U- or V-shaped profile in cross-section, several collars can be molded as a holding device onto one edge of the profile, and said collars form catches that project slightly on the peripheral side on the profile, whereby said catches flexibly deform to produce a frictional connection on the sealing support when the ring element is attached to the sealing support and thus secure the ring element on the sealing support in the form of spring clips.

The collars can be molded onto a radial outer edge of the profile of the ring element or on a radial inner edge of the profile of the ring element. Depending on the type of design of the sealing support and the respective arrangement of the ring element, the catches can thus grip an inside diameter or an outside diameter.

If the sealing support is a flat plate with at least one opening for the exhaust gas flow and the ring element extends along the edge of the respective opening, the frictional connection effecting captive retention can be produced by pressing the collars into the opening edge of the plate opening.

In especially advantageous embodiments, the sealing support as a seat for the ring element has a ring-shaped recess, which surrounds a channel that leads to the exhaust gas flow and is bordered by a wall that extends in an axial direction, with which the collars that form the catches work together.

For this purpose, the arrangement can be designed such that the ring-shaped recess on its radial inner end is open toward the channel that leads to the exhaust gas flow, on a radial outer wall of the recess, a frictional connection being produced with the collars that act as catches.

As an alternative, the recess can have the shape of an annular groove with two walls that exhibit a radial distance from one another and that extend in an axial direction, from which on the radial inner or outer wall, a frictional connection is produced with the collars that act as catches. In such an embodiment, the annular groove forms a chamber for the ring element, by which considerable advantages emerge both with respect to the captive securing of the ring element and with respect to the operating safety of the seal that is formed.

The subject of the invention is also a ring element that is provided for use as a mold seal in the sealing arrangement according to the invention and has the features of claim 10. Additional design features of the ring element according to the invention are indicated in claims 11 to 13.

Below, the invention will be explained in detail based on the embodiments depicted in the drawing. Here:

FIG. 1 shows a top view of an embodiment of the sealing arrangement in the form of a so-called gland for use in the attachment connection between an exhaust gas manifold and a cylinder head, a flat plate being provided as a sealing support and different embodiments of the plate being shown on the right side and the left side in the figure, which are distinguished by differently molded openings for thermal decoupling;

FIG. 2 shows a top view of the ring element, forming a mold seal, of the sealing arrangement according to the invention;

FIG. 3 shows a greatly enlarged detail view of the area defined as III in FIG. 2;

FIG. 4 shows a partial cross-section of the ring element of FIG. 2, greatly enlarged compared to FIG. 2 and drawn in cutaway, and the associated edge section of the opening of the plate of FIG. 1, the condition before attaching the ring element on the plate being shown;

FIG. 5 shows a view that corresponds to FIG. 4, the ring element being shown after the plate is inserted into the opening;

FIG. 6 shows a perspective oblique view of the ring element of the sealing arrangement according to the invention;

FIG. 7 shows a partial cross-section of the ring element that is greatly enlarged compared to FIG. 6, inserted into a recess that acts as a seat of the ring element in a connecting flange that forms the sealing support, and

FIG. 8 shows a partial cross-section, similar to FIG. 7, with, however, on its radial inner profile edge, the ring element being equipped with projecting collars that form catches and being installed in a seat of the sealing support that is formed by an annular groove.

The invention will be explained in greater detail below on the basis of an example, in which the sealing arrangement has the form of a so-called gland, in which a flat metal plate that forms the sealing support has two plate areas 1 and 3 that are integrally connected together via a comparatively narrow plate arm 5, the arm 5 extending along the longitudinal axis 7 of the sealing arrangement. With the center of the circle 9 placed on the longitudinal axis 7, there is one circular opening 11 each for the passage of an exhaust gas flow, which emerges from a respective exhaust opening of a cylinder head (not shown), in each plate area 1 and 3. Screw holes 13 that are located in the two plate areas 1 and 3 are provided for fastening screws, which attach a manifold, not shown, and the sealing arrangement to the cylinder head.

In addition to the screw holes 13, holes 15, which aim at a reduction of the heat-conducting surface area of the sealing arrangement and thus a thermal decoupling between cylinder head and exhaust gas manifold, are located in the plate areas 1 and 3. In FIG. 1, two different embodiments are illustrated for the holes 15; specifically crescent-shaped holes 15 are provided in the plate area 1 on the left, while holes 15 in the form of round holes are provided in the plate area 3 on the right.

For each opening 11, a metal ring element 25 (see FIG. 2) is provided, which has the cross-sectional shape of a C-profile 19. As is the case in the plate with the plate areas 1 and 3, the ring element 25 is also a thin-walled metal component whose wall thickness, as is the case with the plate, is, for example, in the range of 0.3 mm. For a captive securing of the ring element 25 on the respective opening 11 in the associated plate area 1, 3, the ring element 25 has three retaining collars 27 on the profile edge that is opposite its radial outer end 21, and said retaining collars are distributed uniformly on the periphery of the ring element 25, see FIG. 2. As shown most clearly by the enlarged view of FIG. 3, the retaining collars 27 in the (undeformed) initial condition form catch-like projections that project slightly radially on the respective peripheral edge 26 of the ring element 25.

FIG. 4 shows the initial condition shortly before the application of the ring element 25 on the edge of the opening 11 of the respective plate area 1, 3, it being apparent that the retaining collars 27 extend slightly radially outward over the edge of the opening 11. If the ring element is forced into the opening 11 by applying a compressive force corresponding to the force arrow 29, a flexible deformation of the retaining collars 27 occurs when pressing into the opening 11, see FIG. 5, by which a frictional connection, which acts as a holding force, is produced on the opening 11, by which the ring element 25 is held captively on the opening 11.

The ring element 25 can be slightly deformed on its peripheral edge 26 that has the retaining collars 27 by the compressive force that is exerted when it is depressed, by which the compressive force, forming the C-profile 19, produces a slight curvature 23 below the plate 1, 3. FIG. 5 therefore shows a curvature 23 for the ring element 25 on its edge opposite the profile end 21 (peripheral edge 26 in FIG. 3).

Based on FIGS. 6 to 8, a preferred embodiment of the sealing arrangement is explained, in which the sealing support is not a flat plate but rather in which a connecting flange 41, which is located on the outside of an exhaust-gas-carrying channel 43, forms the sealing support. FIG. 7 shows an example in which the seat for the ring element 25 is formed by a ring-shaped recess 45 that is created in the abutting face of the flange 41, which is open on the radial inner end toward the exhaust gas channel 43 and is bordered on the radial outer end by a wall 47 that extends in the axial direction. In the recess 45, the ring element 25 with its retaining collars 27, which are located on the radial outer peripheral edge 26 corresponding to the view of FIG. 6, is installed in the seat, such that the collars 27 are supported under slight flexible deformation as catches on the wall 47 of the recess 45.

FIG. 8 shows an example in which the profile of the ring element 25, unlike in the example of FIGS. 4 to 7, is opened radially inward, and the retaining collars 27 are located on a radial inner profile edge. In this embodiment, an annular groove 49 that surrounds the exhaust gas channel 43 is created in the flange 41 that forms the sealing support instead of the recess 45 that is shown in FIG. 7, and said annular groove 49 is bordered by a radial inner wall 51 that extends in an axial direction and a radial outer wall 53 that extends in an axial direction. In this connection, the retaining collars 27 are supported on the radial inner wall 51, in the same way as in FIG. 7, the frictional connection that ensures captive retention being formed. Also, in the example of FIG. 8, where the annular groove 49 forms a chamber for the ring element 25, a ring element 25 could be installed in the annular groove 49 with a profile that is open radially outward, whereby the retaining collars 27 would be clamped on the radial outer wall 53 as catches. Also, the term “sealing ring or mold” also extends to ring embodiments with oval shape or those with a rectangular design, preferably the corners of the rectangle being designed in a rounded way. Other ring shapes are possible here. In this respect, the respective images of the mold or sealing ring preferably follow the respective geometry thereof.

1. Sealing arrangement, in particular for pipe connections to the exhaust gas system of an internal combustion engine, with a sealing support (1, 3, 41) and at least one sealing element in the form of a ring element (25) that forms a mold seal, characterized in that a holding device (27) that produces a frictional connection between sealing support (1, 3; 41) and ring element (25) is provided to secure the latter captively to the sealing support (1, 3; 41).

2. The sealing arrangement according to claim 1, wherein the ring element (25) that forms the mold seal has a C-, U- or V-shaped profile (19) in cross-section and wherein several collars (27) are molded as a holding device onto one edge (26) of the profile (19), and said collars form catches that project slightly on the peripheral side on the profile (19), whereby said catches flexibly deform to produce a frictional connection on the sealing support (1, 3; 41) when the ring element (25) is attached to the sealing support.

3. The sealing arrangement according to claim 2, wherein the collars (27) are molded onto a radial outer edge (26) of the profile (19) of the ring element (25).

4. The sealing arrangement according to claim 2, wherein the collars (27) are molded onto a radial inner edge of the profile (19) of the ring element (25).

5. The sealing arrangement according to claim 1, wherein the sealing support has a flat plate (1, 3) with at least one opening (11) for the exhaust gas flow and wherein the ring element (25) extends along the edge of the respective opening (11).

6. The sealing arrangement according to claim 3, wherein the collars (27) as catches clamp onto the edge of the respective opening (11) of the plate (1, 3).

7. The sealing arrangement according to claim 34, wherein as a seat for the ring element (25), the sealing arrangement has a ring-shaped recess (45), which surrounds a channel (43) that leads to the exhaust gas flow and is bordered by a wall (47) that extends in an axial direction, with which the collars (27) that form the catches work together.

8. The sealing arrangement according to claim 7, wherein on a radial outer wall (47), the recess (45) produces a frictional connection with the collars (27) that act as catches.

9. The sealing arrangement according to claim 7, wherein the recess has the shape of an annular groove (49) with two walls (51, 53) that are at a radial distance from one another and that extend in an axial direction, from which the radial inner wall (51) produces a frictional connection with the collars (27) that act as catches.

10. Ring element for use as a mold seal in a sealing arrangement according to claim 1, with a profile element (19) with profile edges that are axially at a distance from a principal ring plane, several collars (27), which form slightly projecting catches on the profile edge (26), being molded onto a profile edge (26).

11. The ring element according to claim 10 in the form of a C-profile element (19).

12. The ring element according to claim 10, wherein the collars (27) are molded onto a radial outer profile edge (26) of the profile element (19).

13. The ring element according to claim 10, wherein the collars (27) are molded onto a radial inner profile edge of the profile element (19).
